(19) United States
(12) Patent Application Publication
(10) Pub. No.: US 2024/0064781 A1
(43) Pub. Date: Feb. 22, 2024

(54) METHOD FOR SIDELINK TRANSMISSION OVER UNLICENSED SPECTRUM, USER EQUIPMENT, AND NON-TRANSITORY COMPUTER-READABLE STORAGE MEDIUM

(71) Applicant: SPREADTRUM COMMUNICATIONS (SHANGHAI) CO., LTD., Shanghai (CN)

(72) Inventor: Meng ZHANG, Shanghai (CN)

(21) Appl. No.: 18/261,371

(22) PCT Filed: Feb. 17, 2022
(86) PCT No.: PCT/CN2022/076611

§ 371 Date: Jul. 13, 2023

(30) Foreign Application Priority Data
Jan. 15, 2021 (CN) 202110057762.5

(51) Int. Cl. H04W 72/40; H04W 28/26; H04W 72/25

(52) U.S. Cl. CPC H04W 72/40; H04W 28/26; H04W 72/25

(57) ABSTRACT

A method for sidelink transmission over an unlicensed spectrum is provided. The method includes: determining a mappable position for second sidelink control information (SCI) on a sidelink resource, where the sidelink resource is allocated in an interlace manner; mapping the second SCI to the mappable position in a manner of interlace first and/or a manner of frequency domain first; and transmitting the second SCI by using the sidelink resource.

### CROSS-REFERENCE TO RELATED APPLICATION(S)

This application is a National Stage of International Application No. PCT/CN2022/076611, filed on Feb. 17, 2022, which claims priority to Chinese Patent Application No. 202110057762.5, filed on Jan. 15, 2021, both of which are incorporated herein by reference in their entireties.

### TECHNICAL FIELD

The present disclosure relates to the technical field of communication, and in particular, to a method for sidelink transmission over an unlicensed spectrum, a user equipment, and a non-transitory computer-readable storage medium.

### BACKGROUND

The conventional sidelink transmission remains to be operated over a licensed spectrum regardless of the fourth-generation mobile communications (4G) or the fifth-generation mobile communications (5G). A future protocol will extend the sidelink transmission to a non-licensed spectrum (namely, unlicensed spectrum). In the study of new radio in unlicensed spectrum (NR-U), in order to meet the requirement of occupied channel bandwidth (OCB), the concept of interlace is introduced.

Interlace means that resources are allocated in units of several discrete resource blocks (RBs). One interlace includes several discrete resource blocks. One channel or reference signal (RS) can occupy one or more interlaces.

Channels on a sidelink also need to be redesigned in an interlace manner, so as not to affect sidelink transmission over an unlicensed spectrum.

### SUMMARY

Embodiments of the present disclosure provide a method for sidelink transmission over an unlicensed spectrum, including: determining a mappable position for second sidelink control information (SCI) on a sidelink resource, where the sidelink resource is allocated in an interlace manner; mapping the second SCI to the mappable position in a manner of interlace first and/or a manner of frequency domain first; and transmitting the second SCI by using the sidelink resource.

The embodiments of the present disclosure further provide a user equipment (UE). The UE includes a transceiver, a processor, and a memory configured to store a computer program. The processor is configured to execute the computer program to cause the UE to perform the following. Determine a mappable position for second SCI on a sidelink resource, where the sidelink resource is allocated in an interlace manner. Map the second SCI to the mappable position in a manner of interlace first and/or a manner of frequency domain first. Transmit the second SCI by using the sidelink resource.

The embodiments of the present disclosure further provide a non-transitory computer-readable storage medium. The computer-readable storage medium stores a computer program. The computer program is executed by a UE to perform the following. Determine a mappable position for second SCI on a sidelink resource, where the sidelink resource is allocated in an interlace manner. Map the second SCI to the mappable position in a manner of interlace first and/or a manner of frequency domain first. Transmit the second SCI by using the sidelink resource.

### BRIEF DESCRIPTION OF THE DRAWINGS

FIG. 1 is a flow chart of a method for sidelink transmission over an unlicensed spectrum according to an embodiment of the present disclosure.

FIG. 2 is a schematic diagram of a first typical application scenario of sidelink resource mapping according to an embodiment of the present disclosure.

FIG. 3 is a schematic diagram of a second typical application scenario of sidelink resource mapping according to an embodiment of the present disclosure.

FIG. 4 is a schematic structural diagram of an apparatus for sidelink transmission over an unlicensed spectrum according to an embodiment of the present disclosure.

### DETAILED DESCRIPTION

As described in the background, in the related art, channels on a sidelink also need to be redesigned in an interlace manner, so as not to affect sidelink transmission over an unlicensed spectrum.

In order to solve the foregoing technical problem, embodiments of the present disclosure provide a method for sidelink transmission over an unlicensed spectrum. The method includes the following. Determine a mappable position for second sidelink control information (SCI) on a sidelink resource, where the sidelink resource is allocated in an interlace manner. Map the second SCI to the mappable position in a manner of interlace first and/or a manner of frequency domain first, and transmit the second SCI by using the sidelink resource.

Therefore, channels on a sidelink can be redesigned in an interlace manner, thereby achieving sidelink transmission over an unlicensed spectrum. Specifically, the sidelink resource is allocated in the interlace manner. Further, the second SCI is mapped to the mappable position on the sidelink resource in the manner of interlace first and/or the manner of frequency domain first, thereby achieving interlace-based resource mapping of the second SCI.

To make the foregoing objectives, features, and beneficial effects of the present disclosure more apparent and easier to understand, specific embodiments of the present disclosure are described in detail below with reference to the accompanying drawings.

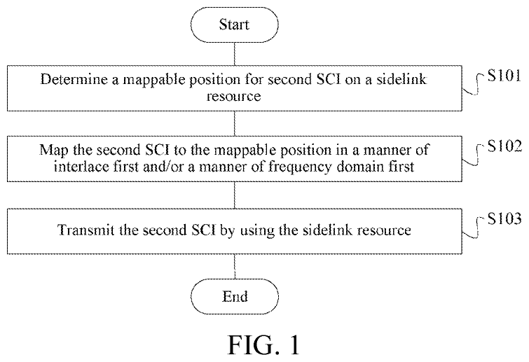

FIG. 1 is a flow chart of a method for sidelink transmission over an unlicensed spectrum according to an embodiment of the present disclosure.

Specifically, a sidelink may be connected to a transmitter (Tx) and a receiver (Rx). Alternatively, the sidelink may also be connected to a base station (gNB) which can transmit information to the receiver through the transmitter.

The embodiment may be executed by the receiver, and the receiver may be user equipment (UE). Specifically, the embodiment may be executed by a chip having a resource mapping function in the UE, or executed by a baseband chip in the UE.

Further, transmission on the sidelink is performed over the unlicensed spectrum.

Further, a sidelink resource is allocated in an interlace manner. One interlace resource can be identified by an interlace index. Resource blocks (RBs) or resource elements (REs) included in one interlace resource can be distributed discretely in a frequency domain.

Referring to FIG. 1, the method for sidelink transmission over an unlicensed spectrum according to the embodiment includes the following.

In S101, determine a mappable position for second SCI on a sidelink resource.

In S102, map the second SCI to the mappable position in a manner of interlace first and/or a manner of frequency domain first.

In S103, transmit the second SCI by using the sidelink resource.

In a specific implementation, S101 may include: determining a resource element to which no demodulation reference signal (DMRS) is mapped in a symbol of the sidelink resource to which a first DMRS of a physical sidelink shared channel (PSSCH) is mapped as the mappable position.

In a specific implementation, S102 may include: mapping the second SCI to the mappable position in descending order of interlace indexes or ascending order of the interlace indexes, where in a single interlace, mapping is performed in ascending order of frequencies in the frequency domain or descending order of the frequencies in the frequency domain. Therefore, a better diversity gain effect can be achieved.

Specifically, mapping may be performed at an interlace level (in ascending or descending order of interlace indexes) first, and then in a single interlace, in ascending or descending order of frequencies in the frequency domain, when mapping for one symbol is completed, mapping for a next symbol is performed.

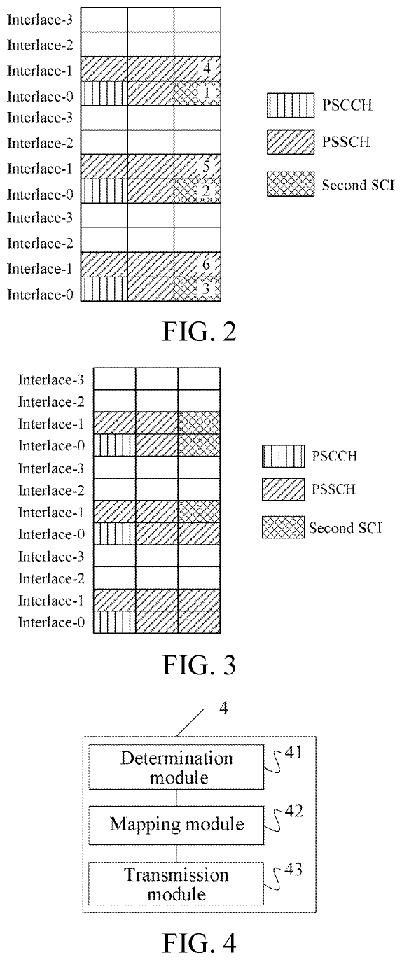

For example, referring to FIG. 2, firstly, a physical sidelink control channel (PSCCH) is mapped onto a sidelink resource in ascending order of interlace indexes, and then a DMRS of a PSSCH is mapped onto a sidelink resource in ascending order of interlace indexes.

A resource element to which no DMRS is mapped in a symbol to which the DMRS is mapped is a mappable position, and then second SCI is mapped to mappable positions in ascending order of interlace indexes and in descending order of frequencies in a frequency domain in a single interlace (i.e., the order of serial numbers illustrated). In FIG. 2, because mapping of the second SCI is completed at a mappable position numbered with 3, the second SCI is actually not mapped to mappable positions numbered with 4, 5, and 6.

Finally, remaining resource elements can carry the PSSCH.

In a specific implementation, mapping the second SCI to the mappable position in the manner of frequency domain first includes: mapping the second SCI to the mappable position in ascending or descending order of frequencies in the frequency domain.

Specifically, the second SCI may be mapped to the mappable position in a mapping manner of frequency domain first and then time domain.

For example, referring to FIG. 3, after a PSCCH and a DMRS of a PSSCH are mapped to sidelink resources, second SCI can be mapped in a manner of frequency domain first and then time domain as shown in FIG. 3.

In a specific implementation, S102 may include: performing mapping for first n−1 symbols in n symbols in the manner of frequency domain first and performing mapping for an nth symbol in the n symbols in the manner of interlace first, on condition that each of the n symbols includes a mappable position, where n≥2.

That is, the second SCI may be mapped to multiple symbols. In this case, mapping for the first n−1 symbols is implemented in a mapping manner of frequency domain first and then time domain as shown in FIG. 3, and mapping for the last symbol is implemented in a scattered mapping manner as shown in FIG. 2.

The three implementations of mapping the second SCI to the sidelink resource in S102 can be executed by the transmitter.

In a specific implementation, the sidelink resource is allocated in the interlace manner as follows. A lowest interlace index of a sidelink resource to which a PSCCH is mapped is consistent with a lowest interlace index of a sidelink resource to which a PSSCH is mapped. Alternatively, the PSCCH can be mapped onto one interlace resource. In this case, an interlace index of the sidelink resource to which the PSCCH is mapped is consistent with the lowest interlace index of the sidelink resource to which the PSSCH is mapped.

That is, the lowest mapping position for the PSCCH in the frequency domain is consistent with the lowest mapping position for the PSSCH in the frequency domain. For example, referring to FIG. 2 and FIG. 3, the lowest interlace index corresponding to mapping of the PSCCH in the frequency domain and the lowest interlace index corresponding to mapping of the PSSCH in the frequency domain are both interlace-0.

In a specific implementation, the method of the embodiment may further include: transmitting reserved resource indication information, where a resource allocation result contained in the reserved resource indication information is calculated based on the following formula:

$$X = ⌈ {log}_{2} ( \frac{{N}_{interlace} ( {N}_{interlace} + 1 ) ( 2 {N}_{interlace} + 1 )}{6} ) ⌉ ,$$

where X represents the resource allocation result, and N_{interlace} represents a total number of interlaces. Optionally, upon receiving the resource indication information, the receiver can calculate a starting interlace resource index for a PSSCH and a total number of interlace resources.

Specifically, the reserved resource indication information can be carried through downlink control information (DCI), SCI, or a PSCCH. The SCI may include the second SCI transmitted in the embodiment as shown in FIG. 1.

Further, the reserved resource indication information can be transmitted by using the sidelink resource allocated in the interlace manner in the embodiment.

Further, the reserved resource indication information can indicate an allocation result of resources reserved for subsequent first and second PSCCH transmissions.

Further, the reserved resource indication information can be transmitted by the transmitter through broadcasting.

Based on the above, with the embodiment, the channels on the sidelink can be redesigned in the interlace manner, thereby achieving sidelink transmission over an unlicensed spectrum. Specifically, the sidelink resource is allocated in the interlace manner. Further, the second SCI is mapped to the mappable position on the sidelink resource in the manner of interlace first and/or the manner of frequency domain first, thereby achieving interlace-based resource mapping of the second SCI.

FIG. 4 is a schematic structural diagram of an apparatus for sidelink transmission over an unlicensed spectrum according to an embodiment of the present disclosure. A person skilled in the art may understand that the apparatus 4 for sidelink transmission over an unlicensed spectrum in the embodiment may be configured to implement the technical solutions of the methods described in the embodiments shown in FIG. 1 to FIG. 3.

Specifically, referring to FIG. 4, the apparatus 4 for sidelink transmission over an unlicensed spectrum according to the embodiment includes a determination module 41, a mapping module 42, and a transmission module 43. The determination module 41 is configured to determine a mappable position for second SCI on a sidelink resource, where the sidelink resource is allocated in an interlace manner. The mapping module 42 is configured to map the second SCI to the mappable position in a manner of interlace first and/or a manner of frequency domain first. The transmission module 43 is configured to transmit the second SCI by using the sidelink resource.

For more contents of the operating principle and the operating mode of the apparatus 4 for sidelink transmission over an unlicensed spectrum, reference can be made to the relevant description in FIG. 1, which is not repeated here.

In a specific implementation, the apparatus 4 for sidelink transmission over an unlicensed spectrum may correspond to a processing chip having a resource mapping function in UE, or correspond to a chip having a data processing function, such as a baseband chip, or correspond to a chip module including a resource mapping chip in the UE, or correspond to a chip module having a data processing function chip, or correspond to the UE.

In a specific implementation, various modules/units included in various apparatuses and products described in the foregoing embodiments may be software modules/units, may be hardware modules/units, or may be partially software modules/units and partially hardware modules/units.

For example, various modules/units included in various apparatuses and products applied or integrated to a chip may be implemented in the form of hardware such as a circuit, or the modules/units may be at least partially implemented in the form of a software program executed on a processor integrated inside the chip. The remaining (if any) modules/units may be implemented in the form of hardware such as a circuit. Various modules/units included in various apparatuses and products applied or integrated to a chip module may be implemented in the form of hardware such as a circuit, different modules/units may be located in the same component (for example, a chip, a circuit module, etc.) or different components of the chip module, or the modules/units may be at least partially implemented in the form of a software program executed on a processor integrated inside the chip module. The remaining (if any) modules/units may be implemented in the form of hardware such as a circuit. Various modules/units included in various apparatuses and products applied or integrated to a terminal may be implemented in the form of hardware such as a circuit, different modules/units may be located in the same component (for example, a chip, a circuit module, etc.) or different components of the terminal, or the modules/units may be at least partially implemented in the form of a software program executed on a processor integrated inside the terminal. The remaining (if any) modules/units may be implemented in the form of hardware such as a circuit.

The embodiments of the present disclosure further provide a computer-readable storage medium. The computer-readable storage medium is a non-volatile storage medium or a non-transitory storage medium having a computer program stored thereon. The computer program is executed by a processor to perform the operations of the method for sidelink transmission over an unlicensed spectrum provided in any of the foregoing embodiments.

The embodiments of the present disclosure further provide another apparatus for sidelink transmission over an unlicensed spectrum, including a memory and a processor. The memory stores a computer program executable on the processor. The processor, when executing the computer program, performs the operations of the method for sidelink transmission over an unlicensed spectrum provided in the embodiment illustrated in FIG. 1 to FIG. 3.

A person of ordinary skill in the art may understand that all or some of the operations of the various methods in the foregoing embodiments may be implemented by hardware, or may be completed by indicating the associated hardware through a program. The program may be stored in a computer-readable storage medium. The storage medium may include: a read-only memory (ROM), a random access memory (RAM), a magnetic disk or optical disc, etc.

The technical solution of the present disclosure may be applied to a fifth generation (5G) communication system, a fourth generation (4G) communication system, and a third generation (3G) communication system, and may be applied to various communication systems subsequently evolved, such as a sixth generation (6G) communication system and a seventh generation (7G) communication system.

The technical solution of the present disclosure may also be applicable to different network architectures, including but not limited to relay network architectures, dual connectivity architectures, and vehicle-to-everything architectures.

The 5G-core network (CN) described in the embodiments of the present disclosure may also be referred to as a new core, or 5G new core, or a next generation core (NGC), etc. The 5G-CN is independent of conventional core networks, such as an evolved packet core (EPC).

A base station (BS) in the embodiments of the present disclosure, also referred to as a base station device, is an apparatus deployed in a radio access network to provide a radio communication function. For example, devices providing base station functions in second generation (2G) networks may include a base transceiver station (BTS) and a base station controller (BSC). Devices providing base station functions in 3G networks include a NodeB and a radio network controller (RNC). Devices providing base station functions in 4G networks include an evolved NodeB (eNB). Devices providing base station functions in wireless local area networks (WLAN) include an access point (AP). Devices providing base station functions in 5G new radio (NR) include a generation NodeB (gNB), and devices providing base station functions in future new communication systems, etc.

The terminal in the embodiments of the present disclosure may refer to various forms of UEs, access terminals, subscriber units, subscriber stations, mobile radio stations, mobile stations (MS), remote stations, remote terminals, mobile devices, user terminals, terminal equipment, wireless communication devices, user agents or user apparatuses. The terminal device may also be a cellular telephone, a cordless telephone, a session initiation protocol (SIP) telephone, a wireless local loop (WLL) station, or a personal digital assistant (PDA), or may be a device having a wireless communication function such as a handheld device, a computing device or other processing devices connected to a wireless modem, a vehicle-mounted device, or a wearable device, or may be a terminal device in a future 5G network or terminal device in a future evolved public land mobile network (PLMN), etc. The embodiments of the present disclosure are not limited thereto.

In the embodiments of the disclosure, a one-way communication link from an access network to a terminal is defined as a downlink, data transmitted on the downlink is downlink data, and a transmission direction of the downlink data is referred to as a downlink direction. A one-way communication link from the terminal to the access network is defined as an uplink, data transmitted on the uplink is uplink data, and a transmission direction of the uplink data is referred to as an uplink direction.

It is to be understood that the term “and/or” herein describes only an association relationship for describing associated objects and represents that three relationships may exist. For example, A and/or B may represent the following three cases: only A exists, both A and B exist, and only B exists. In addition, the character “/” herein indicates an “or” relationship between the associated objects.

In the embodiments of the present disclosure, “a plurality of” or “multiple” means two or more than two.

First, second, and other terms in the embodiments of the present disclosure are only for illustrating and distinguishing the objects described, not in order, and are not intended to be particularly limited to the number of devices in the embodiments of the present disclosure, without any limitation on the embodiments of the present disclosure.

“Connection” or “coupling” in the embodiments of the present disclosure refers to various connection or coupling modes such as direct connection or coupling, or indirect connection or coupling, to realize communication between devices. The embodiments of the present disclosure are not limited thereto.

“Network” and “system” in the embodiments of the present disclosure express the same concept. A communication system is a communication network.

It is to be understood that in the embodiments of the present disclosure, the processor may be a central processing unit (CPU). The processor may also be another general-purpose processor, a digital signal processor (DSP), an application specific integrated circuit (ASIC), a field programmable gate array (FPGA) or another programmable logic device, a discrete gate or transistor logic device, or a discrete hardware component. The general-purpose processor may be a microprocessor, or the processor may be any conventional processor.

It is also to be understood that the memory in the embodiments of the present disclosure may be a volatile memory or a non-volatile memory, or may include both the volatile memory and the non-volatile memory. The non-volatile memory may be a ROM, a programmable ROM (PROM), an erasable PROM (EPROM), an electrically EPROM (EEPROM), or a flash memory.

The volatile memory may be a RAM that serves as an external cache. By way of illustration, but not limitation, many forms of RAM are available, including a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM).

The foregoing embodiments may be implemented in whole or in part by using software, hardware, firmware, or any combination thereof. When implemented by using software, the foregoing embodiments may be implemented in whole or in part in the form of a computer program product. The computer program product includes one or more computer instructions or computer programs. When the computer instructions or the computer programs are loaded or executed on a computer, the procedures or functions according to the embodiments of the present disclosure are generated in whole or in part. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a digital versatile disc (DVD), or a semiconductor medium. The semiconductor medium may be a solid state disk.

It is to be understood that sequence numbers of the processes do not mean an execution sequence in the embodiments of the present disclosure. The execution sequence of the processes should be determined based on functions and internal logic of the processes, and should not be construed as any limitation on implementation processes of the embodiments of the present disclosure.

In the several embodiments provided in the present disclosure, it is to be understood that the disclosed method, apparatus, and system may be implemented in other manners. For example, the described apparatus embodiment is merely an example. For example, the unit division is merely a logical function division and may be other division during actual implementation. For example, multiple units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate components may or may not be physically separated. The components displayed as units may or may not be physical units, and may be located in one place or may be distributed over multiple network units. Some or all of the units may be selected according to actual needs to achieve the objectives of the embodiments of the present disclosure.

In addition, functional units in the embodiments of the present disclosure may be integrated into one processing unit, or each of the units may be physically included, or two or more units may be integrated into one unit. The integrated unit may be implemented in the form of hardware, or may be implemented in a form of hardware plus a software functional unit.

The integrated unit implemented in the form of a software functional unit may be stored in a computer-readable storage medium. The software functional unit is stored in a storage medium and includes multiple instructions for causing a computer device (which may be a personal computer, a server, a network device) to perform some operations of the method in the embodiments of the present disclosure. The foregoing storage medium includes various media capable of storing program codes, such as, a universal serial bus (USB) flash drive, a mobile hard disk, a ROM, a RAM, a magnetic disk, or an optical disc.

Although the present disclosure is disclosed above, the present disclosure is not limited thereto. A person skilled in the art can make various changes and modifications without departing from the spirit and the scope of the present disclosure. Therefore, the protection scope of the present disclosure should be subject to the scope defined by the claims.

1. A method for sidelink transmission over an unlicensed spectrum, comprising:
determining a mappable position for second sidelink control information (SCI) on a sidelink resource, wherein the sidelink resource is allocated in an interlace manner;
mapping the second SCI to the mappable position in a manner of interlace first and/or a manner of frequency domain first; and
transmitting the second SCI by using the sidelink resource.

2. The method according to claim 1, wherein determining the mappable position for the second SCI on the sidelink resource comprises:
determining a resource element to which no demodulation reference signal (DMRS) is mapped in a symbol of the sidelink resource to which a first DMRS of a physical sidelink shared channel (PSSCH) is mapped as the mappable position.

3. The method according to claim 1, wherein mapping the second SCI to the mappable position in the manner of interlace first and the manner of frequency domain first comprises:
performing mapping for first n−1 symbols in n symbols in the manner of frequency domain first and performing mapping for an n^{th} symbol in the n symbols in the manner of interlace first, on condition that each of the n symbols comprises a mappable position, wherein n≥2.

4. The method according to claim 1, wherein mapping the second SCI to the mappable position in the manner of interlace first comprises:
mapping the second SCI to the mappable position in descending order of interlace indexes or ascending order of the interlace indexes, wherein in a single interlace, mapping is performed in ascending order of frequencies in a frequency domain or descending order of the frequencies in the frequency domain.

5. The method according to claim 1, wherein mapping the second SCI to the mappable position in the manner of frequency domain first comprises:
mapping the second SCI to the mappable position in ascending order of frequencies in a frequency domain or descending order of the frequencies in the frequency domain.

6. The method according to claim 1, wherein the sidelink resource being allocated in the interlace manner comprises: a lowest interlace index of a sidelink resource to which a physical sidelink control channel (PSCCH) is mapped is consistent with a lowest interlace index of a sidelink resource to which a PSSCH is mapped.

7. The method according to claim 1, further comprising:
transmitting reserved resource indication information, wherein a resource allocation result contained in the reserved resource indication information is calculated based on the following formula:
$$X = ⌈ {log}_{2} ( \frac{{N}_{interlace} ( {N}_{interlace} + 1 ) ( 2 {N}_{interlace} + 1 )}{6} ) ⌉ ,$$
wherein X represents the resource allocation result, and N_{interlace} represents a total number of interlaces.

8. The method according to claim 7, wherein the reserved resource indication information is carried through downlink control information (DCI) or SCI.

9. The method according to claim 7, wherein the reserved resource indication information is transmitted through broadcasting.

10. A user equipment (UE), comprising:
a transceiver;
a processor; and
a memory configured to store a computer program:
the processor being configured to execute the computer program to cause the UE to:
determine a mappable position for second sidelink control information (SCI) on a sidelink resource, wherein the sidelink resource is allocated in an interlace manner;
map the second SCI to the mappable position in a manner of interlace first and/or a manner of frequency domain first; and
transmit the second SCI by using the sidelink resource.

11. The UE according to claim 10, wherein the processor configured to execute the computer program to cause the UE to determine the mappable position for the SCI on the sidelink resource is configured to execute the computer program to cause the UE to:
determine a resource element to which no demodulation reference signal (DMRS) is mapped in a symbol of the sidelink resource to which a first DMRS of a physical sidelink shared channel (PSSCH) is mapped as the mappable position.

12. The UE according to claim 10, wherein the processor configured to execute the computer program to cause the UE to map the second SCI is configured to execute the computer program to cause the UE to:
perform mapping for first n−1 symbols in n symbols in the manner of frequency domain first and perform mapping for an n^{th} symbol in the n symbols in the manner of interlace first, on condition that each of the n symbols includes a mappable position, wherein n≥2.

13. The UE according to claim 10, wherein the processor configured to execute the computer program to cause the UE to map the second SCI is configured to execute the computer program to cause the UE to:
map the second SCI to the mappable position in descending order of interlace indexes or ascending order of the interlace indexes, wherein in a single interlace, mapping is performed in ascending order of frequencies in a frequency domain or descending order of the frequencies in the frequency domain.

14. The UE according to claim 10, wherein the processor configured to execute the computer program to cause the UE to map the second SCI is configured to execute the computer program to cause the UE to:
map the second SCI to the mappable position in ascending of frequencies in a frequency domain or descending order of the frequencies in the frequency domain.

15. The UE according to claim 10, wherein the sidelink resource being allocated in the interlace manner comprises: a lowest interlace index of a sidelink resource to which a physical sidelink control channel (PSCCH) is mapped is consistent with a lowest interlace index of a sidelink resource to which a PSSCH is mapped.

16. The UE according to claim 10, wherein the processor is further configured to execute the computer program to cause the UE to:
transmit reserved resource indication information, wherein a resource allocation result contained in the reserved resource indication information is calculated based on the following formula:
$$X = ⌈ {log}_{2} ( \frac{{N}_{interlace} ( {N}_{interlace} + 1 ) ( 2 {N}_{interlace} + 1 )}{6} ) ⌉ ,$$
wherein X represents the resource allocation result, and N_{interlace} represents a total number of interlaces.

17. The UE according to claim 16, wherein the reserved resource indication information is carried through downlink control information (DCI) or SCI.

18. The UE according to claim 16, wherein the reserved resource indication information is transmitted through broadcasting.

19. A non-transitory computer-readable storage medium storing a computer program, the computer program being executed by a user equipment (UE) to perform:
determining a mappable position for second sidelink control information (SCI) on a sidelink resource, wherein the sidelink resource is allocated in an interlace manner;
mapping the second SCI to the mappable position in a manner of interlace first and/or a manner of frequency domain first; and
transmitting the second SCI by using the sidelink resource.

20-21. (canceled)

22. The non-transitory computer-readable storage medium of claim 19, wherein the computer program executed by the UE to perform determining the mappable position for the second SCI on the sidelink resource is executed by the UE to perform:
determining a resource element to which no demodulation reference signal (DMRS) is mapped in a symbol of the sidelink resource to which a first DMRS of a physical sidelink shared channel (PSSCH) is mapped as the mappable position.
